(19) United States
(12) Patent Application Publication
(10) Pub. No.: US 2022/0291967 A1
(43) Pub. Date: Sep. 15, 2022

(54) METHOD FOR MANAGING RESOURCES AND ELECTRONIC DEVICE

(71) Applicant: BEIJING DAJIA INTERNET INFORMATION TECHNOLOGY CO., LTD., Beijing (CN)

(72) Inventors: Shuai SHAO, Beijing (CN); Zhijian MA, Beijing (CN)

(21) Appl. No.: 17/804,456

(22) Filed: May 27, 2022

Related U.S. Application Data
(63) Continuation of application No. PCT/CN2020/114441, filed on Sep. 10, 2020.

(30) Foreign Application Priority Data
Nov. 29, 2019 (CN) 201911206785.7

(51) Int. Cl. G06F 9/50

(52) U.S. Cl. CPC G06F 9/5061; G06F 9/505

(57) ABSTRACT

Provided is a method for managing resources. The method includes: determining an author state of a first resource, wherein the first resource is a resource in an online state, and the author state is configured to indicate a state corresponding to author identification of an author to which the first resource belongs; taking the first resource offline in response to the author state being a deactivated state; and marking a management operation type of the first resource as automatically going offline.

### CROSS-REFERENCE TO RELATED APPLICATION

This application is a continuation application of International Application No. PCT/CN2020/114441, filed on Sep. 10, 2020 which claims the benefit of priority to Chinese Application No. 201911206785.7, filed on Nov. 29, 2019, both of which are incorporated by reference herein.

### TECHNICAL FIELD

The present disclosure relates to the field of information technologies, and in particular, to a method for managing resources and an electronic device.

### BACKGROUND

At present, it is very common to view resources in people's daily life, but there are many factors affecting a state of resources, resulting in impossibility to view the resources. At this time, the state of resources needs to be modified.

### SUMMARY

The present disclosure provides a method for managing resources and an electronic device. The technical solutions of the present disclosure are as follows.

According to an aspect of embodiments of the present disclosure, a method for managing resources is provided. The method includes:

determining an author state of a first resource, wherein the first resource is a resource in an online state, and the author state is configured to indicate a state corresponding to author identification of an author to which the first resource belongs;

taking the first resource offline in response to the author state being a deactivated state; and

marking a management operation type of the first resource as automatically going offline.

According to another aspect of the embodiments of the present disclosure, a server is provided. The server includes a processor and a memory, wherein

the memory is configured to store a computer program; and

the processor, when loading and running the computer program stored on the memory, is caused to perform:

determining an author state of a first resource, wherein the first resource is a resource in an online state, and the author state is configured to indicate a state corresponding to author identification of an author to which the first resource belongs;

taking the first resource offline in response to the author state being a deactivated state; and

marking a management operation type of the first resource as automatically going offline.

According to still another aspect of the embodiments of the present disclosure, a non-transitory computer-readable storage medium is provided. The non-transitory computer-readable storage medium stores a computer program therein, wherein the computer program, when loaded and run by a processor, causes the processor to perform:

determining an author state of a first resource, wherein the first resource is a resource in an online state, and the author state is configured to indicate a state corresponding to author identification of an author to which the first resource belongs;

taking the first resource offline in response to the author state being a deactivated state; and

marking a management operation type of the first resource as automatically going offline.

### BRIEF DESCRIPTION OF THE DRAWINGS

FIG. 1 is a schematic diagram of an implementation environment according to some embodiments;

FIG. 2 is a flowchart of a method for managing resources according to some embodiments;

FIG. 3 is a flowchart of another method for managing resources according to some embodiments;

FIG. 4 is a flowchart of a method for managing resources according to some embodiments;

FIG. 5 is a flowchart of still another method for managing resources according to some embodiments;

FIG. 6 is a block diagram of an apparatus for managing resources according to some embodiments;

FIG. 7 is a block diagram of another apparatus for managing resources according to some embodiments;

FIG. 8 is a block diagram of still another apparatus for managing resources according to some embodiments;

FIG. 9 is a block diagram of a server 900 for managing resources according to some embodiments; and

FIG. 10 is a block diagram of a server 1000 for managing resources according to some embodiments.

### DETAILED DESCRIPTION

In the case that a state of ineffective resources is modified manually, the problem of a huge workload occurs and the modification efficiency is relatively low.

With a method for managing resources according to an embodiment of the present disclosure, a resource in an online state can be taken offline based on an author state of the resource, such that the resource is automatically taken offline without manual modification, thereby reducing the labor cost and improving the resource management efficiency. In addition, after the resource is taken offline, a management operation type of the resource is marked as automatically going offline, such that the resource which is taken offline continues to be managed subsequently, thereby improving the resource management accuracy.

The method for managing resources according to the embodiment of the present disclosure is executed by an electronic device. In some embodiments, the electronic device is a terminal, such as a mobile phone, a computer, a tablet computer, or the like. In some embodiments, the electronic device is a server, which is one server, a server cluster consisting of several servers, or a cloud computing service center.

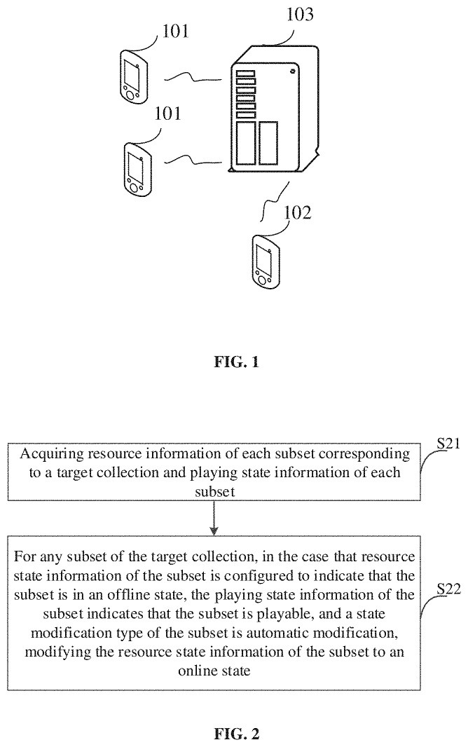

In some embodiments, the electronic device includes a terminal and a server. FIG. 1 is a schematic diagram of an implementation environment according to some embodiments. As shown in FIG. 1, the implementation environment includes at least one first terminal 101, at least one second terminal 102, and a server 103. The at least one first terminal 101 and the at least one second terminal 102 are connected to the server 103 via a wired or wireless network.

A target application served by the server 103 is installed on each of the first terminal 101 and the second terminal 102, and the first terminal 101 and the second terminal 102 may implement functions, such as data transmission and information interaction through the target application. In some embodiments, the target application is a target application in an operating system of the first terminal 101 or the second terminal 102, or a target application provided by a third party. For example, the target application is a content sharing application. The content sharing application has the function of sharing content, for example, sharing video resources and sharing audio resources. In addition, the content sharing application may also have other functions, such as a commenting function, a shopping function, and a game function.

In some embodiments, the first terminal 101 is a terminal used by a user, and the user may share resources, set resource state information of the resources, and the like on the first terminal 101. In the case that the user of the first terminal 101 shares resources through the target application, the user is an author of the resource. Therefore, for the resources shared by the user, the first terminal 101 may be regarded as an author terminal, and various managements, such as privacy setting, for the shared resources may be performed at the author terminal. As there are resources of other authors in the target application, the first terminal 101 may be regarded as an audience user terminal for the resources of the other authors. The second terminal 102 is a management terminal for managing users, who share resources by using the first terminal 101, or managing shared resources, for example, blocking a user and blocking resources. In some embodiments, the management terminal is a terminal used by an administrator of the target application, and the administrator manages, through the second terminal 102, authors who share resources and the resources shared by the authors in the target application. The server 103 is a resource management server which is configured to manage users or the resources in the target application based on a management operation of the second terminal 102, and is also configured to automatically manage resources according to information, such as resource information of the resources and playing state information of the resources.

The method for managing resources according to the embodiment of the present disclosure is aimed at a program in the electronic device. Therefore, in some embodiments, the method is executed by an electronic device, such as a mobile phone or a server. In some embodiments, the mobile phone is the first terminal 101 or the second terminal 102 in FIG. 1. The server is the server 103 in FIG. 1.

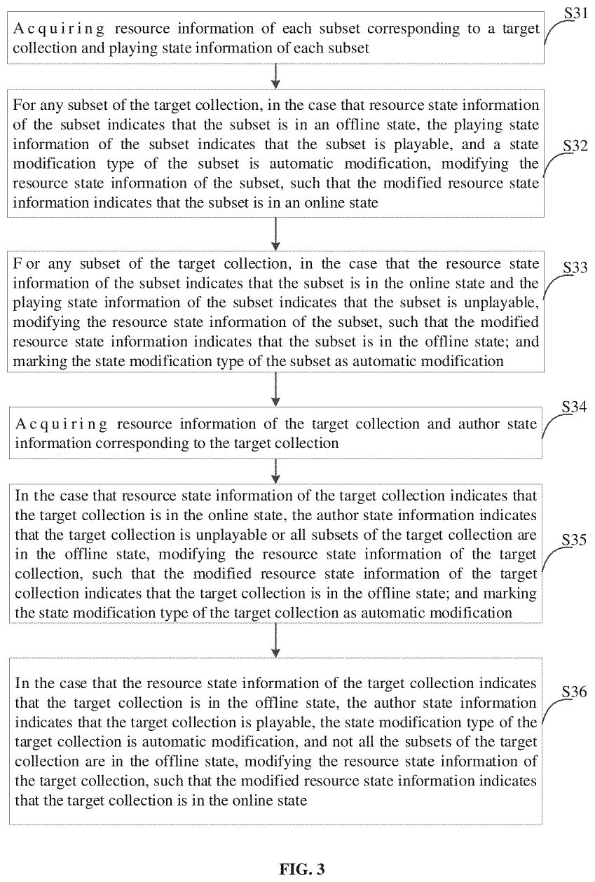

FIG. 2 is a flowchart of a method for managing resources according to some embodiments. The method is executed by a server, as shown in FIG. 1, and includes S21 and S22 as follows.

In S21, resource information of each subset corresponding to a target collection and playing state information of each subset are acquired.

In S22, for any subset of the target collection, in the case that resource state information of the subset is configured to indicate that the subset is in an offline state, the playing state information of the subset indicates that the subset is playable, and a state modification type of the subset is automatic modification, the resource state information of the subset is modified to an online state.

For S21, the target collection refers to a collection consisting of at least one subset. In some embodiments, the target collection is a complete work consisting of a plurality of subsets. For example, the target collection is a TV drama, a radio drama, audiobook, or the like. In some embodiments, the target collection includes a plurality of subsets uploaded by the same user. For example, in a video sharing platform, the target collection is all works uploaded by the same user.

In some embodiments, the subset is a resource, such as a complete video or audio. For example, the subset is any episode in the TV drama, any episode in the radio drama, any chapter in the audiobook, any work uploaded by the user on the video sharing platform, or the like.

When the server acquires the resource information of each subset corresponding to the target collection, various subsets are subsets corresponding to the target collection. For example, for a TV drama including 12 episodes, the target collection is the TV drama, and the various subsets are 12 episodes corresponding to the TV drama.

In some embodiments, after acquiring the resource information of each subset corresponding to the target collection and the playing state information of each subset, the server establishes a database and saves subset information (such as subset identification) of each subset corresponding to the target collection and the playing state information of each subset in the database. The server may subsequently acquire the playing state information of any subset from the database to determine a playing state of the subset.

The resource information of the subset includes the resource state information and a state modification type. The resource state information of the subset is configured to indicate that the subset is in an online state or the offline state. When the resource state information of the subset indicates that the subset is in the online state, the subset is visible to the user, and the user may search for, access, or read the subset from the server. When the resource state information of the subset indicates that the subset is in the offline state, the subset is invisible to the user, or the subset is invisible to audience users and visible to an author of the subset.

In some embodiments, the server takes the subset online, such that the subset is in the online state. The expression “take . . . online” may mean that the author uploads the subset to the server and the server adds the subset to a query form, or the subset taken offline is restored to the server. After the subset taken offline is taken online, the resource state information of the subset changes, such that the subset changes from the offline state to the online state.

In some embodiments, the server takes the subset offline, such that the subset is in the offline state. The expression “take . . . offline” may mean that the subset is deleted from the query form of the server, such that the subset is invisible to the user.

The state modification type includes automatic modification or non-automatic modification. In the case that the state modification type of the subset includes automatic modification, it indicates that the resource state information of the subset is modified non-manually. In the case that the state modification type of the subset includes non-automatic modification, it indicates that the resource state information of the subset is modified manually.

The playing state information of the subset indicates whether the subset is playable, and is configured to indicate that the subset is in a playable state or an unplayable state. In some embodiments, the playing state information of the subset is configured to indicate that the subset is in a public state or a privacy state. In the case that the playing state information indicates that the subset is in the public state, the subset is playable. In the case that the playing state information indicates that the subset is in the privacy state, the subset is unplayable. In some embodiments, the author to which the subset belongs may set the playing state information of the subset and set the subset to be in the public state or the privacy state.

In some embodiments, the subset is a video. The video being in the online state indicates that the video is in a user-visible state, and the video being in the offline state indicates that the video is in a user-invisible state. The user is a user of a certain video platform, and the user may watch public content on the video platform. That is, the user may watch visible content on the video platform. In some embodiments, the subset is an audio. The case that the audio is in the online state is similar to the case that the video is in the online state, and the case that the audio is in the offline state is similar to the case that the video is in the offline state, which is not repeated here.

For example, for a TV drama including 12 episodes, acquiring, by the server, the resource information of each subset corresponding to the target collection and the playing state information of each subset includes: acquiring, by the server, the resource information and playing state information of all 12 episodes corresponding to the TV drama, wherein the first episode is in the online state, that is, the user-visible state, and the remaining episodes are in the offline state, that is, the user-invisible state.

For S22, automatic modification means non-manual modification, and the resource state information of the subset indicates a current state of the subset. For example, for a certain subset, the current state of the subset is the offline state. In the case that the author to which the subset belongs sets the subset to be in the privacy state, the current state of the subset is in the offline state, that is, an invisible state.

The playing state information of the subset is configured to indicate whether the subset is playable. In some embodiments, the playing state information is configured to indicate that the subset is in the playable state or the unplayable state. For example, the author to which the subset belongs sets the subset to be in the public state, such that the playing state information of the subset changes, and the changed playing state information indicates that the subset is in the playable state. The author of the subset sets the subset to be in the privacy state, such that the playing state information of the subset changes, and the changed playing state information indicates that the subset is in the unplayable state.

The state modification type of the subset may be configured to indicate whether the subset is taken online or offline automatically. For example, in the case that the author to which the subset belongs sets the subset to be in the privacy state to take the subset offline, the subset is a subset taken offline automatically, that is, the state modification type of the subset is automatic modification.

The author to which the subset belongs sets the subset to be in the privacy state to take the subset offline, such that the subset is the subset taken offline automatically, which means that the author to which the subset belongs sets the subset to be in the privacy state, the playing state information of the subset changes, and the changed playing state information indicates that the subset is in the unplayable state. In this way, when the server acquires the playing state information of the subset and the acquired playing state information indicates that the subset is in the unplayable state, that is, the subset is unplayable, the server takes the subset offline, that is, modifies the resource state information of the subset, such that the modified resource state information is configured to indicate that the resource is in the offline state. As the process is automatically performed, the subset is the subset taken offline automatically.

In another example, in the case that the subset is taken forcibly offline by an operator, the subset is modified non-automatically.

The author is an author to which the subset belongs, that is, a producer or uploader of the subset. The author can modify the playing state information of the subset uploaded to a certain platform.

In some embodiments, after the author modifies the subset from the privacy state to the public state, the subset is taken online automatically, that is, the resource state information of the subset is modified accordingly, such that the subset is in the online state. For example, the author modifies the playing state information of the subset on the terminal, and the terminal sends a playing state modification instruction to the server based on a modification operation of the author. The playing state modification instruction includes subset identification and modified playing state information. The server acquires the resource information of the subset in response to the playing state modification instruction. The resource information includes the resource state information and the state modification type. In the case that the resource state information of the subset indicates that the subset is in the offline state, the modified playing state information of the subset indicates that the subset is in the playable state, and the state modification type of the subset is automatic modification, the resource state information of the subset is modified, such that the resource state information indicates that the subset is in the online state. After the resource state information is modified, the subset may be displayed on terminals of other users besides the author, and the users can watch the subset. That is, the server can automatically trigger a management process in response to a change of the playing state information.

In some embodiments, a task for automatically managing the resource online or offline is set in the server, and the server periodically performs the task to continuously take the subset online or offline for managing.

By determining whether the state modification type of the subset is automatic modification, different management methods may be adopted for different types of offline subsets based on offline reasons, thereby preventing the subset that should not be taken online from being taken online. In addition, the subset is automatically modified based on the resource information of each subset corresponding to the target collection and the playing state information of each subset. Compared with the related art in which whether the collection is taken online or offline is determined based on related information stored in a database, such as author information, duration, the number of playback times, and video sources of the overall collection and subsets, the method for managing resources according to the embodiment of the present disclosure has the advantages that whether the resource is taken online or offline can be automatically determined and automatically set only based on the subset information and the video state information, which reduces the amount of data in the database, avoids poor performance of determining whether to take information online or offline caused by too much redundant data, and improves the performance in the process of state determination.

Based on the above embodiments, in some embodiments, the method for managing resources also includes: for any subset of the target collection, in the case that the resource state information of the subset indicates that the subset is in the online state and the playing state information of the subset indicates that the subset is unplayable, the resource state information of the subset is modified, such that the modified resource state information indicates that the subset is in the offline state, and the state modification type of the subset is marked as automatic modification.

The resource state information of the subset is configured to indicate the current state of the subset. For example, for a certain subset, in the case that the current state of the subset is in the online state, and after the author to which the subset belongs sets the subset to be in the privacy state, the server acquires the playing state information of the subset, which indicates that the subset is unplayable, and the server takes the subset offline, that is, modifies the resource state information of the subset and the modified resource state information indicates that the subset is in the offline state. Moreover, the server may also mark the state modification type of the subset as automatic modification. In some embodiments, the automatic modification includes automatically offline. The server marking the state modification type of the subset as automatic modification includes: the server marking the state modification type of the subset as automatically going offline.

In some embodiments, the playing state information includes author state information. The method for managing resources also includes: acquiring resource information of the target collection and author state information corresponding to the target collection.

The author state information is configured to indicate whether a collection of an author is playable. The author state information is state information of author identification of the author in a management system. The management system is a system for managing resources, that is, a system for performing the method for managing resources according to the embodiments of the present disclosure. In some embodiments, the system is a server.

The author state information of the target collection indicates that a resource of the author to which the target collection belongs is in the playable or the unplayable state. In some embodiments, the author state information is configured to indicate that the author identification of the author is in the public state or a blocked state. The public state indicates that the collection of the author to which the target collection belongs is in the playable state, and the blocked state indicates that the collection of the author to which the target collection belongs is in the unplayable state. In some embodiments, the public state includes an always public state or an unblocked state. The always public state means that the author identification of the author to which the target collection belongs is always in the public state. The unblocked state indicates that the author identification of the author to which the target collection belongs was once in the blocked state, and is unblocked and in the unblocked state at present.

In some embodiments, in the case that the author has some illegal operations, the server may correspondingly modify the author state information of the author to block the author. For example, the server modifies the author state information of the author, such that the author state information indicates that the author is in the blocked state. Accordingly, the server also needs to take the collection of the author offline. In some embodiments, blocking the author includes permanently blocking the author, or blocking the author for a period of time, such as one day and one month. When the blocking time is reached, the author is unblocked. For example, the server modifies the author state information of the author, such that the author changes from the blocked state to the unblocked state. Accordingly, the server also needs to take the collection of the author online.

In some embodiments, the author state information is also configured to indicate other states, which is not limited in the embodiments of the present disclosure.

For example, in the case that the author state information of the author indicates that the author is in the blocked state, it can be determined, based on the author state information, that the collection corresponding to the author is unplayable.

The resource information of the target collection includes resource state information of the target collection, and the resource state information of the target collection indicates that the target collection is in the online state or the offline state. The online state and the offline state indicate whether the target collection is in the user-visible state. The online state indicates that the target collection is in the user-visible state, and the offline state indicates that the target collection is in the user-invisible state.

In the case that the resource state information of the target collection indicates that the target collection is in the online state, assuming that the author state information indicates that the target collection of the author is unplayable or all subsets of the target collection are in the offline state, the resource state information of the target collection is modified, such that the modified resource state information indicates that the target collection is in the offline state, and the state modification type of the target collection is marked as automatic modification. The state modification type may also be called a management operation type, which is configured to indicate a management mode of the target collection.

For example, for a certain collection, in the case that the server determines, after acquiring the author state information, that the author of the collection is blocked, that is, the collection corresponding to the author is unplayable or each subset corresponding to the collection is in the offline state, the server sets the state of the collection to the offline state and the state modification type of the collection is marked as automatic modification.

It should be noted that the process of managing the target collection is performed after each subset of the target collection is managed. In this way, it can be ensured that the resource state information of each subset of the target collection is accurate resource state information.

In some embodiments, the method for managing resources also includes: in the case that the resource state information of the target collection indicates that the target collection is in the offline state, the author state information indicates that the target collection is playable, the state modification type of the target collection is automatic modification, and not all subsets of the target collection are in the offline state, the resource state information of the target collection is modified, such that the modified resource state information indicates that the target collection is in the online state. That not all subsets of the target collection are in the offline state means that at least one subset of the target collection is in the online state.

For example, for a certain collection, in the case that the author of the collection is unblocked and the state modification type of the collection is automatic modification, or some subsets in the collection change from the privacy state to the public state, the resource state information of the collection is modified, such that the modified resource state information indicates that the collection is in the online state. That some subsets in the collection change from the privacy state to the public state means that some subsets in the collection change from the offline state to the online state, that is, not all subsets in the target collection are in the offline state.

It can be seen that through the method for managing resources according to the embodiments of the present disclosure, the resource state information of the resource can be modified based on the playing state information of the resource, such that the resource is taken online automatically without manual modification, thereby reducing the labor cost and improving the resource management efficiency. In addition, in a management process, whether the resource which is taken online is playable and whether the offline state of the resource is automatically modified are considered, such that the normal playing of the resource taken online can be ensured and the resource which is taken offline non-automatically is prevented from being taken online again, thereby improving the resource management accuracy.

FIG. 3 is a flowchart of another method for managing resources according to some embodiments. The method is executed by a server, as shown in FIG. 3, and includes S31 to S36 as follows.

In S31, resource information of each subset corresponding to a target collection and playing state information of each subset are acquired.

In S32, for any subset of the target collection, in the case that resource state information of the subset indicates that the subset is in an offline state, the playing state information of the subset indicates that the subset is playable, and a state modification type of the subset is automatic modification, the resource state information of the subset is modified, such that the modified resource state information indicates that the subset is in an online state.

In S33, for any subset of the target collection, in the case that the resource state information of the subset indicates that the subset is in the online state and the playing state information of the subset indicates that the subset is unplayable, the resource state information of the subset is modified, such that the modified resource state information indicates that the subset is in the offline state; and the state modification type of the subset is marked as automatic modification.

In S34, resource information of the target collection and author state information corresponding to the target collection are acquired.

In S35, in the case that resource state information of the target collection indicates that the target collection is in the online state, the author state information indicates that the target collection is unplayable, or all subsets of the target collection are in the offline state, the resource state information of the target collection is modified, such that the modified resource state information of the target collection indicates that the target collection is in the offline state, and a state modification type of the target collection is marked as automatic modification.

In S36, in the case that the resource state information of the target collection indicates that the target collection is in the offline state, the author state information indicates that the target collection is playable, the state modification type of the target collection is automatic modification, and not all subsets of the target collection are in the offline state, the resource state information of the target collection is modified, such that the modified resource state information indicates that the target collection is in the online state.

In the case that the resource state information of the subset indicates that the subset is in the online state and the playing state information of the subset indicates that the subset is unplayable, the resource state information of the subset is modified, such that the modified resource state information indicates that the subset is in the offline state. For example, the subset is taken offline. Assuming that the author sets the subset, which is previously set to be in a public state, to be in a privacy state, the subset is taken offline, and the state modification type of the subset is marked as automatic modification.

In some embodiments, “the resource state information of the subset is modified, such that the modified resource state information indicates that the subset is in the offline state” is equivalent to that the subset is taken offline. Accordingly, “the resource state information of the subset is modified, such that the modified resource state information indicates that the subset is in the online state” is equivalent to that the subset is taken online. For example, when displaying at least one resource to a user through an aggregated resource display interface, the terminal acquires the at least one resource from the server and displays the at least one resource on the aggregated resource display interface, and the server distributes the resource based on the resource state information of the resource, distributes the resource in the online state to the terminal, and does not distribute the resource in the offline state to the terminal. Therefore, the terminal does not display resources that have been taken offline.

For any subset of the target collection, in the case that the subset is in the online state, the subset may be set to be in the offline state and the state modification type of the subset may be marked as automatic modification, to facilitate taking the subset online again.

For S34, the resource information of the target collection includes the resource state information of the target collection, and the resource state information of the target collection indicates that the target collection is in the online state or the offline state. In other words, a resource state of the target collection includes the online state or the offline state.

The author state information is configured to indicate whether a collection corresponding to an author is playable. For example, when the author is in a blocked state, it can be determined, based on the author state information, that the collection corresponding to the author is unplayable. In some embodiments, after the resource information of the target collection and the author state information corresponding to the target collection are acquired, a database is established, and the resource information of the target collection and the author state information corresponding to the target collection are saved in the database. The state of the target collection can be determined by acquiring the resource information and the author state information of the target collection from the database

In some embodiments, the resource information of each subset of the target collection and the playing state information of each subset, as well as the resource information of the target collection and the author state information corresponding to the target collection are correspondingly stored in the same database, to facilitate managing various states of the target collection and each subset in the target collection.

By acquiring the resource information of the target collection and the author state information corresponding to the target collection, the state of the target collection is determined, and the target collection is taken online or offline automatically based on the determined state. For example, the state of the collection is modified based on the resource information of the target collection, and the author state information corresponding to the target collection. Compared with the related art in which whether the collection is taken online or offline is determined based on related information stored in the database, such as author information, duration, the number of playback times, and video sources of the overall collection and subsets, the method for managing resources according to the embodiments of the present disclosure has the advantages that whether the target collection is taken online or offline can be automatically determined and automatically set only based on the resource information and the author state information, which reduces the amount of data in the database, avoids poor performance of determining whether to take information online or offline caused by too much redundant data, and improves the performance in the process of state determination.

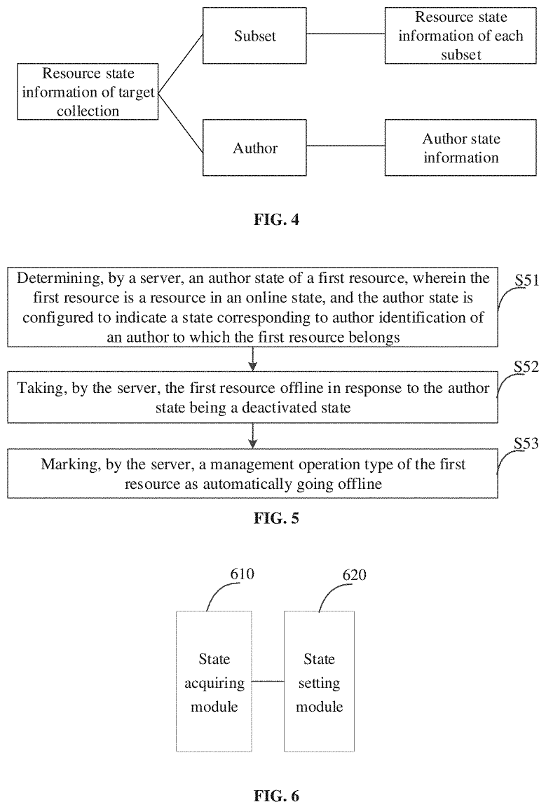

For S35, as shown in FIG. 4, the resource state information of the target collection is determined based on the resource state information of each subset of the target collection, or the author state information of the target collection, or both the resource state information of each subset of the target collection and the author state information of the target collection.

For example, for a certain collection, in the case that the server determines, after acquiring the author state information, that an author of the collection is blocked, that is, the collection corresponding to the author is unplayable, or that all subsets corresponding to the collection are in the offline state, the server sets the collection to be in the offline state and modifies the state modification type of the collection as automatic modification.

In the case that the resource state information of the target collection indicates that the target collection is in the online state, through condition-based determination, the target collection is set to be in the offline state and the state modification type of the target collection is marked as automatic modification. In this way, whether the collection is taken offline can be automatically determined, and the collection that meets offline conditions is taken offline automatically. In addition, the state modification type of the collection is marked, thereby facilitating automatically taking the collection online subsequently.

For S36, not all subsets of the target collection being in the offline state means that at least one subset of the target collection is in the online state.

In the case that the resource state information of the target collection indicates that the target collection is in the offline state, the target collection is set to be in the online state through determination based on online conditions. In this way, whether the collection is taken online can be automatically determined, and the collection that meets online conditions is taken online automatically.

It can be seen that through the method for managing resources according to the embodiments of the present disclosure, the resource state information of the resource can be modified based on the playing state information of the resource, such that the resource is taken online automatically without manual modification, thereby reducing the labor cost and improving the resource management efficiency. In addition, in a management process, whether the resource which is taken online is playable and whether the offline state of the resource is automatically modified are considered, such that the normal playing of the resource taken online can be ensured and the resource which is taken offline non-automatically is prevented from being taken online again, thereby improving the resource management accuracy.

The process of modifying the resource state information of any subset is illustrated in FIG. 2, and the process of modifying the resource state information of the target collection is illustrated in FIG. 3. It should be noted that the embodiments of the present disclosure are not limited to the above subset or target collection. In fact, for any resource, the solution of the above embodiments can be used for state modification. In some embodiments, the resource is the subset or the target collection in the above embodiments. In some embodiments, the resource may be other resources.

Therefore, the server acquires the resource information of the resource, wherein the resource information includes the resource state information and the state modification type, the resource state information being configured to indicate that the resource is in the online state or the offline state, and the state modification type including automatic modification or non-automatic modification; acquires the playing state information of the resource, wherein the playing state information is configured to indicate that the resource is in the playable state or the non-playable state; and modifies the resource state information of the resource in the case that the resource state information indicates that the resource is in the offline state, the playing state information indicates that the resource is in the playable state, and the state modification type is automatic modification, such that the modified resource state information indicates that the resource is in the online state.

The above resource is a resource in any data format. For example, the resource is a video resource, an audio resource, or the like. In another example, the resource is any movie resource, any TV drama resource, any episode resource of any TV drama, any audiobook resource, any song resource, or the like.

In some embodiments, the resource is any subset in the target collection.

The target collection is a set of a plurality of subsets. For example, the target collection is a TV drama, and the subset is any episode of the TV drama; the target collection is a set of works of the same author, and the subset is any work of the author; or the like.

In some embodiments, in the case that the resource state information of any subset indicates that the subset is in the online state and the playing state information of the subset indicates that the subset is in the unplayable state, the resource state information of the subset is modified, such that the modified resource state information indicates that the subset is in the offline state, and the state modification type is marked as automatic modification.

In some embodiments, the resource is the target collection including a plurality of subsets. In the case that the resource state information of the target collection indicates that the target collection is in the offline state, the playing state information of the target collection indicates that the target collection is in the playable state, the state modification type is automatic modification, and at least one subset of the target collection is in the online state, the resource state information of the target collection is modified, such that the modified resource state information indicates that the target collection is in the online state.

In some embodiments, in the case that the resource state information of the target collection indicates that the target collection is in the online state and all subsets of the target collection are in the offline state, the resource state information of the target collection is modified, such that the modified resource state information indicates that the target collection is in the offline state, and the state modification type of the target collection is marked as automatic modification.

In some embodiments, the playing state information includes author state information. The author state information indicates that the resource of the author to which the resource belongs is in the playable state or the unplayable state.

In some embodiments, the author state information is configured to indicate the state of the author, including the public state or the blocked state. The public state indicates that the resource of the author to which the resource belongs is in the playable state, and the blocked state indicates that the resource of the author to which the resource belongs is in the unplayable state. In some embodiments, the public state includes an always public state or an unblocked state. The always public state means that the author to which the target collection belongs is always in the public state. The unblocked state indicates that the author to which the target collection belongs is once in the blocked state, and is unblocked and in the unblocked state at present.

In some embodiments, the playing state information is configured to indicate that the resource is in a public state or a privacy state. The public state indicates that the resource is in the playable state and the privacy state indicates that the resource is in the unplayable state.

Based on the process of modifying the resource state information of any subset in FIG. 2 and the process of modifying the resource state information of the target collection in FIG. 3 above, it can be seen that the server may automatically take the resource online or offline based on the author state and privacy settings of the resource. A process for managing the resource is illustrated below.

FIG. 5 is a flowchart of still another method for managing resources according to some embodiments. The method is executed by a server, as shown in FIG. 5, and includes steps S51 to S53 as follows.

In S51, the server determines an author state of a first resource, wherein the first resource is a resource in an online state, and the author state is configured to indicate a state corresponding to author identification of an author to which the first resource belongs.

In S52, the server takes the first resource offline in response to the author state being a deactivated state.

In S53, the server marks a management operation type of the first resource as automatically going offline.

For S51, the resource is a resource in any data format. For example, the resource is a video resource, an audio resource, or the like. In another example, the resource is any movie resource, any TV drama resource, any audiobook resource, any song resource, or the like.

The first resource is the resource in the online state, that is, an online resource. The first resource being in the online state means that the first resource is visible to a user on the server, and the server may search for, access, or read the first resource. In some embodiments, the author (that is, a user who uploads the resource) may upload the resource to the server, and the server adds the resource to a query form. Subsequently, the server may search for, access, or read the resource based on the query form, such that when the user accesses the server, the server may read the resource based on the query form and recommend the resource to the user. Therefore, when the first resource is in the online state, the first resource is visible to the user.

In some embodiments, the author uploads the resource to the server, and the server also sets resource state information for the resource. The resource state information is configured to indicate a state of the resource. For example, the resource state information is configured to indicate that the resource is in the online state or an offline state. The server may acquire the resource state information of the resource to determine whether the resource is the online resource or an offline resource. The online resource refers to a resource in the online state, and the offline resource refers to a resource in the offline state. In step S51 above, the server may only determine the author state of the online resource.

The resource uploaded by the author to the server can be pushed to other users for viewing. Therefore, it is necessary to ensure that the resource shared by the author is compliant and legal. In the case that an author often uploads some non-compliant or illegal resources to the server, author identification of the author may be blocked or canceled, to prohibit the author from uploading resources to the server and also prohibit the resources of this author from being pushed to other users. Blocking or canceling the author identification of the author can change the author state of the author accordingly. For example, in the case that the author identification of the author is blocked or canceled, the author state of the author is the deactivated state. In some embodiments, the deactivated state may be a blocked state, a canceled state, or the like.

In some embodiments, the server stores the author identification and the author state corresponding to the author identification. After determining the online resource, the server may acquire the author identification of the online resource and determine the author state of the online resource based on the author identification of the online resource.

For S52, when the author state is the deactivated state, the resource of the author is unplayable. As the first resource is the online resource, other users may acquire the first resource by accessing the server, but cannot normally view the first resource after acquiring the first resource. To reduce this, in the embodiments of the present disclosure, the server may automatically take the resource online or offline; and takes the online resource offline in response to the online resource being unplayable to prevent unplayable resources from being provided to users.

In some embodiments, taking the first resource offline refers to deleting the first resource from the query form of the server, such that the server cannot acquire the first resource by searching and the first resource is not provided to the user. Thus, the first resource is invisible to the user.

In some embodiments, the server changes the state of the resource by modifying the resource state information of the resource. For example, the resource state information of the resource being 1 indicates that the resource is in the online state, and the resource state information of the resource being 0 indicates that the resource is in the offline state. The server modifies the resource state information from 1 to 0, such that the resource changes from the online state to the offline state, that is, the server takes the resource offline.

In some embodiments, taking the first resource offline includes: deleting the first resource from the query form of the server and modifying the resource state information of the first resource, such that the modified resource state information indicates that the first resource is in the offline state. In some embodiments, taking the first resource offline includes: modifying the resource state information of the first resource, such that the modified resource state information indicates that the first resource is in the offline state; and deleting the first resource from the query form of the server in response to the resource state information of the first resource indicating that the first resource changes from the online state to the offline state.

For S53, in the embodiments of the present disclosure, a management operation type is added for the resource in the server. After the first resource is taken offline, the management operation type of the first resource may be marked as automatically going offline. In this way, when the offline resource in the offline state is managed, whether the offline resource is automatically taken offline by the server may be known based on the management operation type of the offline resource.

In some embodiments, the server may take the resource online or offline, and a management terminal may also take the resource online or offline. The management terminal may be an administrator of a target application or the server, for managing resources in the target application or the server. The administrator may manually take some resources online or offline through the management terminal. It should be noted that in the case that the online resource is taken offline by the administrator through the management terminal, the management operation type of the resource is marked as being manually offline.

In the embodiments of the present disclosure, the server can not only take the online resource offline, but also can take the offline resource online. The following illustration is given by taking that “the server takes the offline resource online” as an example.

In some embodiments, the method for managing resources further includes: determining, by the server, an author state of a second resource, wherein the second resource is a resource which is in the offline state and of which management operation type is marked as automatically going offline; and taking the second resource online in response to the author state changing from the deactivated state to an activated state.

The second resource is the resource in the offline state, that is, the offline resource. In the embodiments of the present disclosure, to prevent resources which are taken offline by the administrator manually from being taken online, only the offline resource of which the management operation type is marked as automatically going offline is taken online. Therefore, the server determines the author state of the second resource which is in the offline state and of which management operation type is marked as automatically going offline.

In some embodiments, the server determines a third resource in the offline state based on the resource state information of the resource, and selects the second resource of which management operation type is automatically offline from the third resource based on the management operation type of the third resource. In some embodiments, after automatically taking the online resource offline, the server writes resource identification of the resource into a target list, and subsequently takes the offline resource online based on the target list. For example, the server determines, based on the target list, the second resource, determines the author state of the second resource, and takes the second resource online in response to the author state changing from the deactivated state to the activated state.

The author state of the resource being the activated state indicates that the author to which the resource belongs can upload the resource to the server, or that the resource uploaded to the server by the author to which the resource belongs is playable. In some embodiments, the activated state may be a public state, or the like. When the author state is the activated state, the resource of the author is playable.

In some embodiments, the author state of the second resource changing from the deactivated state to the activated state indicates that the second resource changes from the unplayable state to the playable state. Therefore, after acquiring the second resource from the server, the user may play the second resource normally. Therefore, the second resource may be taken online, such that the user can acquire the second resource from the server.

In some embodiments, taking the second resource online refers to restoring the second resource to the server, such as restoring the second resource to the query form of the server. In some embodiments, taking the second resource online refers to modifying the resource state information of the second resource, such that the modified resource state information indicates that the second resource is in the online state.

In some embodiments, taking the second resource online includes: modifying the resource state information of the second resource, such that the modified resource state information indicates that the second resource is in the online state; and restoring the second resource to the query form of the server in response to the second resource changing from the offline state to the online state.

In some embodiments, the first resource includes a plurality of subsets. In some embodiments, the second resource includes a plurality of subsets. That is, each of the first resource and the second resource may be any collection.

It should be noted that when the resource includes a plurality of subsets, the state of the resource is related to the states of the plurality of subsets. By taking the first resource as an example, the process of taking the resource online or offline based on the various subsets of the resource is illustrated as follows.

In some embodiments, the method for managing resources further includes: determining, by the server, a subset state of each of the subsets of the first resource; and taking the first resource offline in response to the subset state of the subset being an offline state.

The subset state of the subset is the online state or the offline state. The subset state of the subset being the online state indicates that the subset is in the online state. The subset state of the subset being the offline state indicates that the subset is in the offline state. In the case that the subset state of each of the subsets in the first resource is the offline state, the first resource acquired by the user from the server is empty. To reduce this, the server takes the resource offline in the case that the subset state of each of the subsets of the resource is the offline state.

In some embodiments, the server stores the resource state information of each of the subsets of the resource. The resource state information is configured to indicate the state of the subset. For example, the resource state information is configured to indicate that the subset is in the online state or the offline state. In some embodiments, the server determines the subset state of each of the subsets by acquiring the resource state information of each of the subsets.

It should be noted that the server not only can manage the resource for automatically taking online or offline, but also can manage the subsets in the resources for automatically taking online or offline.

In some embodiments, the method for managing resources further includes: managing, by the server, the subset based on privacy setting information of the subset. The privacy setting information is configured to indicate whether the subset is in an externally invisible state.

An author of the subset may set the privacy of the subset. For example, the author sets subset in a public state to be in a privacy state. The privacy setting information is configured to indicate whether the subset is set to be in the privacy state by the author. In the case that the subset is not set to be in the privacy state by the author, the subset is in an externally visible state. In the case that the subset is set to be in the privacy state by the author, the subset is in the externally invisible state.

Managing the subset may include: taking the subset online or taking the subset offline. A method for managing the subset is not limited in the embodiments of the present disclosure.

In some embodiments, managing, by the server, the subset based on the privacy setting information of the subset includes: determining the privacy setting information of an online subset; taking the subset offline in response to the privacy setting information indicating that the subset is in the externally invisible state; and marking a management operation type of the subset as automatically going offline.

The online subset refers to a subset in the online state. In the embodiments of the present disclosure, after the author of the subset sets the subset to be in the privacy state or the externally invisible state, the server automatically takes the subset offline. The case that the subset is taken offline is similar to the case that the resource is taken offline, and is not repeated here.

In some embodiments, managing, by the server, the subset based on the privacy setting information of the subset includes: determining the privacy setting information of an offline subset of which management operation type is marked as automatically going offline; and taking the subset online in response to the privacy setting information indicating that the subset is in the externally visible state.

The offline subset refers to a subset in the offline state. In the embodiments of the present disclosure, after the author of the subset sets the subset to be in the privacy state or the externally invisible state, the server may automatically take the subset offline. After the author of the subset sets the subset to be in the public state or the externally visible state, the server may also automatically take the subset online. The case that the subset is taken online is similar to the case that the resource is taken online, and is not repeated here.

It should be noted that in the embodiments of the present disclosure, the method for managing resources is similar to the method for managing the subset and is not repeated here.

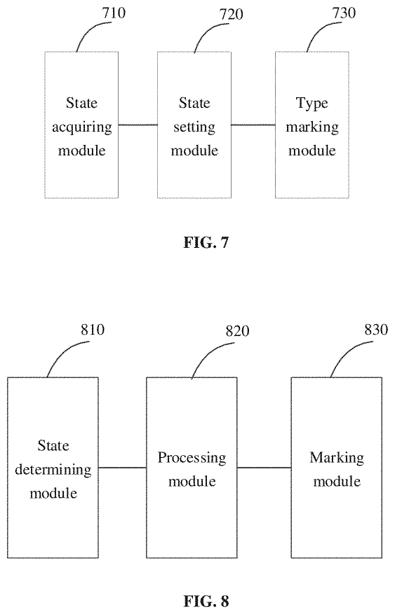

FIG. 6 is a block diagram of an apparatus for managing resources according to some embodiments. Referring to FIG. 6, the apparatus includes a state acquiring module 610 and a state setting module 620.

The state acquiring module 610 is configured to acquire resource information of the resource. The resource information includes resource state information and a state modification type. The resource state information is configured to indicate that the resource is in an online state or an offline state, and the state modification type includes automatic modification or non-automatic modification.

The state acquiring module 610 is further configured to acquire playing state information of the resource. The playing state information is configured to indicate that the resource is in a playable state or an unplayable state.

The state setting module 620 is configured to modify the resource state information of the resource in the case that the resource state information indicates that the resource is in the offline state, the playing state information indicates that the resource is in the playable state, and the state modification type is automatic modification, such that the modified resource state information indicates that the resource is in the online state.

In some embodiments, the resource is a target collection or any subset in the target collection.

In some embodiments, the apparatus for managing resources above further includes:

a type marking module configured to modify the resource state information in the case that the resource state information indicates that the resource is in the online state, and the playing state information indicates that the resource is in the unplayable state, such that the modified resource state information indicates that the resource is in the offline state; and mark the state modification type as automatic modification.

In some embodiments, the resource is a target collection including a plurality of subsets. The state setting module 620 is further configured to modify the resource state information of the target collection in the case that the resource state information of the target collection indicates that the target collection is in the offline state, the playing state information of the target collection indicates that the target collection is in the playable state, the state modification type is automatic modification, and at least one subset of the target collection is in the online state, such that the modified resource state information indicates that the target collection is in the online state.

In some embodiments, the apparatus for managing resources above further includes:

a type marking module configured to modify the resource state information of the target collection in the case that the resource state information of the target collection indicates that the target collection is in the online state and all the subsets of the target collection are in the offline state, such that the modified resource state information indicates that the target collection is in the offline state; and mark the state modification type of the target collection as automatic modification.

In some embodiments, the playing state information is author state information. The author state information indicates that resources of an author to which resource belongs are in the playable state or the unplayable state.

In some embodiments, the author state information is configured to indicate that the author is in a public state or a blocked state. The public state indicates that the resources of the author to which the resource belongs are in the playable state and the blocked state indicates that the resources of the author to which the resource belongs are in the unplayable state. In some embodiments, the public state includes an always public state or an unblocked state.

In some embodiments, the playing state information is configured to indicate that the resource is in a public state or a privacy state. The public state indicates that the resource is in the playable state and the privacy state indicates that the resource is in the unplayable state.

It can be seen that through the apparatus for managing resources according to the embodiments of the present disclosure, the resource state information of the resource can be modified based on the playing state information of the resource, such that the resource is taken online automatically without manual modification, thereby reducing the labor cost and improving the resource management efficiency. In addition, in a management process, whether the resource which is taken online is playable and whether the offline state of the resource is automatically modified are considered, such that the normal playing of the resource taken online can be ensured and the resource which is taken offline non-automatically is prevented from being taken online again, thereby improving the resource management accuracy.

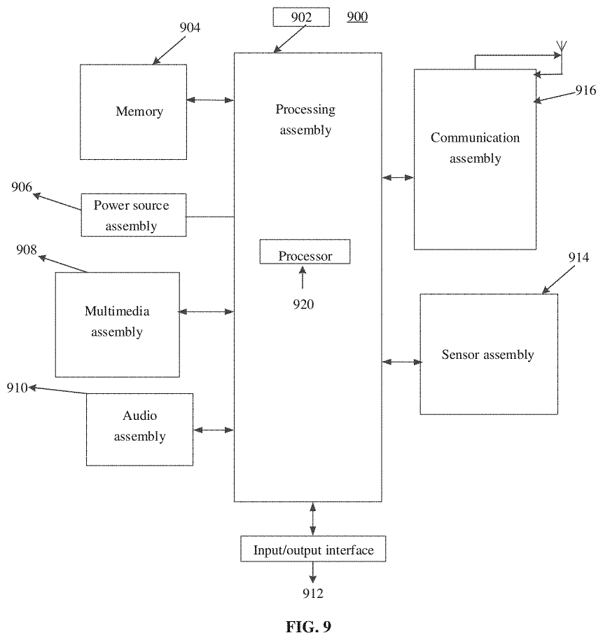

FIG. 7 is a block diagram of an apparatus for managing resources according to some embodiments. Referring to FIG. 7, the apparatus includes a state acquiring module 710, a state setting module 720, and a type marking module 730.

The state acquiring module 710 is configured to acquire resource information of the resource. The resource information includes resource state information and a state modification type. The resource state information is configured to indicate that the resource is in an online state or an offline state, and the state modification type includes automatic modification or non-automatic modification.

The state acquiring module 710 is further configured to acquire playing state information of the resource. The playing state information is configured to indicate that the resource is in a playable state or an unplayable state.

The state setting module 720 is configured to modify the resource state information of the resource in the case that the resource state information indicates that the resource is in the offline state, the playing state information indicates that the resource is in the playable state, and the state modification type is automatic modification, such that the modified resource state information is configured to indicate that the resource is in the online state.

The type marking module 730 is configured to modify the resource state information of the resource in the case that the resource state information is configured to indicate that the resource is in the online state and the playing state information is configured to indicate that the resource is in the unplayable state, such that the modified resource state information indicates that the resource is in the offline state; and the state modification type as automatic modification.

The state setting module 720 is further configured to modify resource state information of a target collection in the case that the resource state information of the target collection indicates that the target collection is in the offline state, playing state information of the target collection is configured to indicate that the target collection is in the playable state, the state modification type is automatic modification, and at least one subset of the target collection is in the online state, such that the modified resource state information is configured to indicate that the target collection is in the online state.

The type marking module 730 is configured to modify the resource state information of the target collection in the case that the resource state information of the target collection is configured to indicate that the target collection is in the online state and all subsets of the target collection are in the offline state, such that the modified resource state information indicates that the target collection is in the offline state; and mark the state modification type of the target collection as automatic modification.

It can be seen that through the apparatus for managing resources according to the embodiments of the present disclosure, the resource state information of the resource can be modified based on the playing state information of the resource, such that the resource is taken online automatically without manual modification, thereby reducing the labor cost and improving the resource management efficiency. In addition, in a management process, whether the resource which is taken online is playable and whether the offline state of the resource is automatically modified are considered, such that the normal playing of the resource taken online can be ensured and the resource which is taken offline non-automatically is prevented from being taken online again, thereby improving the resource management accuracy.

FIG. 8 is a block diagram of an apparatus for managing resources according to some embodiments. Referring to FIG. 8, the apparatus includes a state determining module 801, a processing module 802, and a marking module 803.

The state determining module 801 is configured to determine an author state of a first resource. The first resource is a resource in an online state and the author state is configured to indicate a state corresponding to author identification of an author to which the first resource belongs.

The processing module 802 is configured to take the first resource offline in response to the author state being a deactivated state.

The marking module 803 is configured to mark a management operation type of the first resource as automatically going offline.

In some embodiments, the state determining module 801 is configured to determine an author state of a second resource. The second resource is a resource which is in an offline state and of which management operation type is marked as automatically going offline.

The processing module 802 is configured to take the second resource online in response to the author state changing from the deactivated state to an activated state.

In some embodiments, the first resource includes a plurality of subsets.

In some embodiments, the state determining module 801 is configured to determine a subset state of each of the subsets of the first resource; and

the processing module 802 is configured to take the first resource offline in response to the subset state of the subset being an offline state.

In some embodiments, the processing module 802 is configured to manage the subset based on privacy setting information of the subset. The privacy setting information is configured to indicate whether the subset is in an externally invisible state.

In some embodiments, the processing module 802 is configured to determine the privacy setting information of an online subset; and take the subset offline in response to the privacy setting information indicating that the subset is in the externally invisible state.

The marking module 803 is configured to mark a management operation type of the subset as automatically going offline.

In some embodiments, the processing module 802 is configured to determine the privacy setting information of an offline subset of which management operation type is marked as automatically going offline; and take the subset online in response to the privacy setting information indicating that the subset is in an externally visible state.

FIG. 9 is a block diagram of an electronic device 900 for managing resources according to some embodiments. For example, the electronic device 900 is provided as a terminal. For example, the electronic device 900 may be a mobile phone, a computer, a digital broadcast terminal, a message transceiving device, a game console, a tablet device, a medical device, a fitness device, a personal digital assistant, or the like.

Referring to FIG. 9, the electronic device 900 includes one or more of the following assemblies: a processing assembly 902, a memory 904, a power source assembly 906, a multimedia assembly 908, an audio assembly 910, an input/output (I/O) interface 912, a sensor assembly 914, and a communication assembly 916.

The processing assembly 902 usually controls the overall operation of the electronic device 900, such as operations associated with display, telephone call, data communication, camera operation, and recording operation. The processing assembly 902 includes one or more processors 920 to execute instructions, to complete all or part of the steps of the above method. In addition, the processing assembly 902 includes one or more modules to facilitate interaction between the processing assembly 902 and other assemblies. For example, the processing assembly 902 includes a multimedia module to facilitate interaction between the multimedia assembly 908 and the processing assembly 902.

The memory 904 is configured to store various types of data to support operations on the electronic device 900. The examples of the data include an instruction of any application or method operated on the electronic device 900, contact person data, telephone book data, a message, a picture, a video, and the like. The memory 904 is implemented by any type of a volatile storage device or a non-transitory storage device or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or an optical disk.

The power source assembly 906 provides power for various assemblies of the electronic device 900. The power source assembly 906 includes a power source management system, one or more power sources, and other components associated with generation, management, and distribution of power for the electronic device 900.

The multimedia assembly 908 includes a screen that provides an output interface and is located between the electronic device 900 and a user. In some embodiments, the screen includes a liquid crystal display (LCD) and a touch panel (TP). In the case that the screen includes a touch panel, the screen is implemented as a touch screen, to receive an input signal from the user. The touch panel includes one or more touch sensors to sense touch, sliding, and a gesture on the touch panel. The touch sensor not only senses a boundary of a touch or sliding action, but also detects duration and pressure related to the touch or sliding operation. In some embodiments, the multimedia assembly 908 includes a front-facing camera and/or a back-facing camera. When the device 900 is in an operation mode, such as a shooting mode or a video mode, the front-facing camera and/or the back-facing camera may receive external multimedia data. In some embodiments, each of the front-facing camera and the back-facing camera is a fixed optical lens system or has a focal length and an optical zooming capacity.

The audio assembly 910 is configured to output and/or input an audio signal. For example, the audio assembly 910 includes a microphone (MIC). The microphone is configured to receive an external audio signal when the electronic device 900 is in the operation mode, such as a call mode, a recording mode, and a speech recognition mode. In some embodiments, the received audio signal is further stored in the memory 904, or sent via the communication assembly 916. In some embodiments, the audio assembly 910 further includes a loudspeaker for outputting the audio signal.

The I/O interface 912 is an interface provided between the processing assembly 902 and a peripheral interface module. In some embodiments, the above peripheral interface module is a keyboard, a click wheel, a button, or the like. These buttons include, but are not limited to a homepage button, a volume button, a start button, and a locking button.

The sensor assembly 914 includes one or more sensors for providing the electronic device 900 with state assessment of various aspects. For example, the sensor assembly 914 may detect an opening/closing state of the electronic device 900, and relative positioning of the assembly, such as the display and a small keypad of the electronic device 900. The sensor assembly 914 may also detect a position change of the electronic device 900 or one assembly of the electronic device 900, whether the user contacts the electronic device 900, an orientation and/or acceleration/deceleration of the electronic device 900 and a temperature change of the electronic device 900. In some embodiments, the sensor assembly 914 includes a proximity sensor configured to detect the presence of nearby objects without any physical contact. In some embodiments, the sensor assembly 914 further includes an optical sensor, such as a CMOS or CCD image sensor used in an imaging application. In some embodiments, the sensor assembly 914 also includes an acceleration sensor, a gyroscope sensor, a magnetic sensor, a pressure sensor, or a temperature sensor.

The communication assembly 916 is configured to facilitate wired or wireless communication between the electronic device 900 and other devices. The electronic device 900 may access a wireless network based on a communication standard, such as Wi-Fi, and operator networks (such as 2G, 3G, 4G, or 5G), or a combination thereof. In one exemplary embodiment, the communication assembly 916 receives a broadcast signal or broadcast-related information from an external broadcast management system via a broadcast channel. In one exemplary embodiment, the communication assembly 916 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In some embodiments, the electronic device 900 is implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic units, which are configured to perform the method for managing resources above.

In some embodiments, a non-transitory computer-readable storage medium including a computer program, such as a memory 904 including a computer program, is further provided. The computer program may be executed by the processor 920 of the electronic device 900 to perform the method for managing resources above. In some embodiments, the non-transitory computer-readable storage medium is an ROM, a random-access memory (RAM), a CD-ROM, a magnetic tape, a floppy disk, an optical data storage device, or the like.

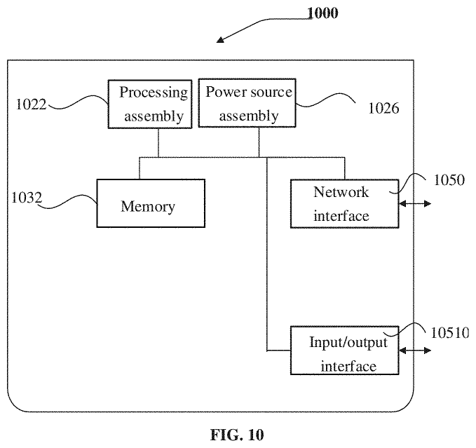

FIG. 10 is a block diagram of an electronic device 1000 for managing resources according to some embodiments. For example, the electronic device 1000 is provided as a server. Referring to FIG. 10, the electronic device 1000 includes a processing assembly 1022 which further includes one or more processors, and memory resources represented by a memory 1032 for storing an instruction that is executable by the processing assembly 1022, such as an application. In some embodiments, the application stored in the memory 1032 includes one or more modules, each corresponding to a set of instructions. In addition, the processing assembly 1022 is configured to execute an instruction, to execute the method for managing resources above.

In some embodiments, the electronic device 1000 further includes a power source assembly 1026 configured to manage a power source of the electronic device 1000; a wired or wireless network interface 1050 configured to connect the electronic device 1000 to a network; and an input/output (I/O) interface 10510. An operation of the electronic device 1000 is based on an operating system stored in the memory 1032, such as WindowsServer™, MacOSX™, Unix™ Linux™, FreeBSD™, or the like.

An embodiment of the present disclosure further provides an electronic device.

The electronic device includes a processor and a memory.

The memory is configured to store a computer program.

The processor, when loading and running the computer program stored on the memory, is caused to perform the method for managing resources above.

An embodiment of the present disclosure further provides a non-transitory computer-readable storage medium storing a computer program therein. The computer program, when loaded and run by a processor, causes the processor to perform the method for managing resources above.

An embodiment of the present disclosure further provides a computer program product. The computer program product, when executed by a computer, causes the computer to perform the method for managing resources above.

Other embodiments of the present disclosure will be apparent to those skilled in the art upon consideration of the specification and practice of the present disclosure. The present disclosure is intended to cover any variations, uses, or adaptations of the present disclosure following general principles of the present disclosure and including the common general knowledge or conventional technical means in the art which is not disclosed in the present disclosure. The specification and embodiments are to be considered as exemplary only, and a true scope and spirit of the present disclosure are indicated by the following claims.

It should be understood that the present disclosure is not limited to the exact structure that has been described above and illustrated in the accompanying drawings, and that various modifications and changes can be made without departing from the scope thereof. It is intended that the scope of the present disclosure is only limited by the appended claims.

What is claimed is:

1. A method for managing resources, applicable to a server, the method comprising:
determining an author state of a first resource, wherein the first resource is a resource in an online state, and the author state is configured to indicate a state corresponding to author identification of an author to which the first resource belongs;
causing the first resource to go offline in response to the author state being a deactivated state; and
marking a management operation type of the first resource as automatically going offline.

2. The method according to claim 1, further comprising:
determining an author state of a second resource, wherein the second resource is a resource which is in an offline state and of which management operation type is marked as automatically going offline; and
causing the second resource to go online in response to the author state changing from the deactivated state to an activated state.

3. The method according to claim 1, wherein the first resource comprises a plurality of subsets.

4. The method according to claim 3, further comprising:
determining a subset state of each of the subsets of the first resource; and
causing the first resource to go offline in response to the subset state of the subset being an offline state.

5. The method according to claim 3, further comprising:
managing the subset based on privacy setting information of the subset, wherein the privacy setting information is configured to indicate whether the subset is in an externally invisible state.

6. The method according to claim 5, wherein said managing the subset based on the privacy setting information of the subset comprises:
determining the privacy setting information of an online subset;
causing the subset to go offline in response to the privacy setting information indicating that the subset is in the externally invisible state; and
marking a management operation type of the subset as automatically going offline.

7. The method according to claim 5, wherein said managing the subset based on the privacy setting information of the subset comprises:
determining the privacy setting information of an offline subset of which management operation type is marked as automatically going offline; and
causing the subset to go online in response to the privacy setting information indicating that the subset is in an externally visible state.

8. A server, comprising a processor and a memory, wherein
the memory is configured to store a computer program; and
the processor, when loading and running the computer program stored on the memory, is caused to perform:
determining an author state of a first resource, wherein the first resource is a resource in an online state, and the author state is configured to indicate a state corresponding to author identification of an author to which the first resource belongs;
causing the first resource to go offline in response to the author state being a deactivated state; and
marking a management operation type of the first resource as automatically going offline.

9. The server according to claim 8, wherein the processor, when loading and running the computer program stored on the memory, is further caused to perform:
determining an author state of a second resource, wherein the second resource is a resource which is in an offline state and of which management operation type is marked as automatically going offline; and
causing the second resource to go online in response to the author state changing from the deactivated state to an activated state.

10. The server according to claim 8, wherein the first resource comprises a plurality of subsets.

11. The server according to claim 10, wherein the processor, when loading and running the computer program stored on the memory, is further caused to perform:
determining a subset state of each of the subsets of the first resource; and
causing the first resource to go offline in response to the subset state of the subset being an offline state.

12. The server according to claim 10, wherein the processor, when loading and running the computer program stored on the memory, is further caused to perform:
managing the subset based on privacy setting information of the subset, wherein the privacy setting information is configured to indicate whether the subset is in an externally invisible state.

13. The server according to claim 12, wherein the processor, when loading and running the computer program stored on the memory, is further caused to perform:
determining the privacy setting information of an online subset;
causing the subset to go offline in response to the privacy setting information indicating that the subset is in the externally invisible state; and
marking a management operation type of the subset as automatically going offline.

14. The server according to claim 12, wherein the processor, when loading and running the computer program stored on the memory, is further caused to perform:
determining the privacy setting information of an offline subset of which a management operation type is marked as automatically going offline; and
causing the subset to go online in response to the privacy setting information indicating that the subset is in an externally visible state.

15. A non-transitory computer-readable storage medium storing a computer program therein, wherein the computer program, when loaded and run by a processor, causes the processor to perform:
determining an author state of a first resource, wherein the first resource is a resource in an online state, and the author state is configured to indicate a state corresponding to author identification of an author to which the first resource belongs;
causing the first resource to go offline in response to the author state being a deactivated state; and
marking a management operation type of the first resource as automatically going offline.

16. The non-transitory computer-readable storage medium according to claim 15, wherein the computer program, when loaded and run by the processor, causes the processor to perform:
determining an author state of a second resource, wherein the second resource is a resource which is in an offline state and of which management operation type is marked as automatically going offline; and
causing the second resource to go online in response to the author state changing from the deactivated state to an activated state.

17. The non-transitory computer-readable storage medium according to claim 15, wherein the first resource comprises a plurality of subsets.

18. The non-transitory computer-readable storage medium according to claim 17, wherein the computer program, when loaded and run by the processor, causes the processor to perform:
determining a subset state of each of the subsets of the first resource; and
causing the first resource to go offline in response to the subset state of the subset being an offline state.

19. The non-transitory computer-readable storage medium according to claim 17, wherein the computer program, when loaded and run by the processor, causes the processor to perform:
managing the subset based on privacy setting information of the subset, wherein the privacy setting information is configured to indicate whether the subset is in an externally invisible state.

20. The non-transitory computer-readable storage medium according to claim 19, wherein the computer program, when loaded and run by the processor, causes the processor to perform:
determining the privacy setting information of an online subset;
causing the subset to go offline in response to the privacy setting information indicating that the subset is in the externally invisible state; and
marking a management operation type of the subset as automatically going offline.
